(19) United States
(12) Patent Application Publication
(10) Pub. No.: US 2007/0189671 A1
(43) Pub. Date: Aug. 16, 2007

(54) Method for manufacturing optical waveguide chip

(75) Inventors: Kentarou Tamaki, Tokyo (JP); Hideaki Takase, Tokyo (JP); Jun Huangfu, Tokyo (JP); Yuuichi Eriyama, Tokyo (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: SR Corporation, Chuo-ku (JP)

(21) Appl. No.: 10/591,913

(22) PCT Filed: Feb. 23, 2005
(86) PCT No.: PCT/JP05/03410

§ 371 Date: Mar. 26, 2007

(30) Foreign Application Priority Data
Mar. 9, 2004 (JP) 2004-065631

(51) Int. Cl. G02B 6/30

(52) U.S. Cl. 385/49

(57) ABSTRACT

An optical waveguide chip having an optical waveguide which can keep good transmission characteristics stably over a long period of time without separations or cracks even in severe use conditions, and an optical fiber guide portion formed without cracks firmly with a shape and a size corresponding to those of an optical fiber is provided. An optical waveguide chip 1 has a support 2, an optical waveguide 3 having a core portion 7, clad layers 6 and 8, an optical fiber guide portion 4 for positioning an optical fiber to be connected with the optical waveguide 3, and a cover member (glass plate) 5. The optical waveguide 3 is made of a radiation-sensitive polysiloxane composition. The optical fiber guide portion 4 is made of the same or a different radiation-sensitive polysiloxane composition as/from the material of the optical waveguide 3. The optical waveguide 3 and the optical fiber guide portion 4 are formed by separate processes.

### TECHNICAL FIELD

The present invention relates to a method for manufacturing an optical waveguide chip which is useful as a constituent part of an optical component such as an optical multiplexer/demultiplexer used for optical communications, and more particularly relates to a method for manufacturing an optical waveguide chip which is mainly used for being connected with a single-mode optical fiber.

### BACKGROUND ART

When an optical fiber is connected with an optical waveguide, it is essential to precisely align the optical axis of the optical fiber with the optical axis of the optical waveguide (i.e. aligning axes) in order to reduce optical transmission loss at the connection site.

As a general method for aligning axes, there is known a method of finding the position with highest light intensity by changing the position of the optical fiber variously and using a fiber array and a power meter. However, there are problems such that it takes 10 minutes or more to align the axes of one pair of ports and that an expensive alignment device such as the fiber array is needed.

Thus, there is a need for a technique in which the optical axis of the optical fiber can be precisely aligned with the optical axis of the optical waveguide in a simple and easy manner without an expensive alignment device.

As an example of such technique, there has been proposed an optical device in which an optical waveguide and an optical axis aligning guide are formed simultaneously by performing photolithography on a radiation-sensitive resin on a support (see Japanese Laid-Open Patent Publication H1-316710). This publication discloses a radiation-sensitive resin composition comprising a polymer such as poly(methyl methacrylate) and polystyrene, a multifunctional (meth)acrylate monomer, and a photo initiator as an example of the radiation-sensitive resin composition used for the optical device.

### DISCLOSURE OF THE INVENTION

A polymer optical waveguide has the advantage of being manufactured in various shapes easily and effectively. However, the polymer optical waveguide has difficulty in keeping good transmission characteristics (i.e. low transmission loss) stably over a long period of time without any separations or cracks under severe temperature conditions. Therefore, a material that has all of the characteristics as described above is desired.

On the other hand, it is not necessary for an optical fiber guide portion to have good transmission characteristics required for the optical waveguide, and the only characteristics that the optical fiber guide portion has to have are high dimensional accuracy, and difficulty in causing cracks or separations, because the optical fiber guide portion is a means for fixing the optical fiber at a prescribed position.

In this regard, in the technique described in Japanese Laid-Open Patent Publication H1-316710, the optical waveguide and the optical axis aligning guide (i.e. the optical fiber guide portion) are made of the same material. That is, two kinds of materials, which depend on the respective characteristics required for the optical waveguide and the optical axis aligning guide, are not required.

Moreover, in the above technique, the optical axis aligning guide and the optical waveguide are simultaneously formed, resulting in that the optical axis aligning guide has the same height as the optical waveguide. Accordingly, the shape and the size of the optical axis aligning guide cannot be determined freely.

Therefore, it is an object of the present invention to provide a method for manufacturing an optical waveguide chip in an easy and efficient manner at low cost, wherein the optical waveguide chip comprises a firm optical fiber guide portion which has a shape and a size corresponding to those of an optical fiber and has no cracks, and an optical waveguide which can keep good transmission characteristics (i.e. low transmission loss) stably over a long period of time without any separations or cracks even in severe conditions in use.

The inventors perfected the present invention upon discovering that the above problems can be solved by using a specific radiation-sensitive (i.e. photosensitive) composition as the material for the optical waveguide, forming the optical waveguide by one process, and forming the optical fiber guide portion by another process in the method for manufacturing the optical waveguide chip having the optical waveguide and the optical fiber guide portion.

Namely, the method for manufacturing an optical waveguide chip of the present invention is characterized in that the optical waveguide chip comprises an optical waveguide and an optical fiber guide portion for positioning the optical fiber to be connected with the optical waveguide, and that the method includes the following steps (A) and (B):

(A) a step for forming the optical waveguide using a radiation-sensitive polysiloxane composition;

(B) a step for forming the optical fiber guide portion using the same or a different radiation-sensitive composition as/from the material of the optical waveguide.

The method for manufacturing an optical waveguide chip of the present invention may include (C) a step for fixing a cover member on the upper surface of the optical waveguide formed by the above step (A).

A preferable example of the radiation-sensitive polysiloxane composition in the method for manufacturing an optical waveguide chip is a composition which comprises the following components (a) and (b) and which has a silanol (Si—OH) group content of from 10 to 50 percent based on the total bonds on Si in the composition: (a) at least one type of compound selected from the group consisting of hydrolysates of hydrolyzable silane compounds represented by the following general formula (1), and condensation products of said hydrolysates,
(R¹)ₚ(R²)_{q}Si(X)_{4-p-q} (1)
[In the formula, R¹ is a non-hydrolyzable organic group having 1 to 12 carbon atoms and at least one fluorine atoms; R² is a non-hydrolyzable organic group having 1 to 12 carbon atoms

(excepting a group having a fluorine atom); X is a hydrolyzable group; p is 1 or 2; q is 0 or 1.];

(b) a photo-acid generator.

Since the optical waveguide, which is a constituent part of the optical waveguide chip obtained by the method of the present invention, is a cured product of the radiation-sensitive polysiloxane composition, the optical waveguide can keep good transmission characteristics (i.e. low transmission loss) stably over a long period of time without any separations or cracks even under severe conditions in use.

When the optical waveguide and the optical fiber guide portion are formed simultaneously and integrally to be one molded product having a Y-shape horizontal section using a radiation-sensitive polysiloxane composition, it may happens that cracks appear around the boundary between the optical waveguide and the optical fiber guide portion. In the present invention, the appearance of such cracks can be effectively suppressed, because the optical waveguide and the optical fiber guide portion are formed by the separate processes.

Also, since the optical fiber guide portion is formed by the separate process from the process for forming the optical waveguide, the optical fiber guide portion has a high degree of freedom in choice for its material, shape, and size. For example, it is possible to reduce the cost of manufacturing the optical waveguide chip by using inexpensive material for the optical fiber guide portion, or to enhance the manufacturing efficiency and reduce the amount of the material by reducing the thickness (i.e. the height from a support) of the optical fiber guide portion than that of the optical waveguide.

Moreover, since both of the optical waveguide and the optical fiber guide portion are formed using radiation-sensitive compositions to which photolithography can be applied, the optical waveguide chip can be manufactured in an easy and efficient manner at low cost.

### BRIEF DESCRIPTION OF THE DRAWINGS

FIG. 1 is a perspective view illustrating an example of an optical waveguide chip of the present invention;

FIG. 2 is a flow diagram illustrating an example of a method for manufacturing the optical waveguide chip shown in FIG. 1.

### BEST MODE FOR CARRYING OUT THE INVENTION

The method for manufacturing an optical waveguide chip of the present invention is a method for manufacturing an optical waveguide chip comprising an optical waveguide and an optical fiber guide portion for positioning an optical fiber to be connected with the optical waveguide, and includes the following steps (A) and (B):

(A) a step for forming the optical waveguide by using a radiation-sensitive polysiloxane composition;

(B) a step for forming the optical fiber guide portion by using the same or a different radiation-sensitive composition as/from the material of the optical waveguide.

Note that any one of the steps (A) and (B) is provided as the former step, and the other one as the latter step.

A typical example of the optical waveguide chip obtained by the method of the present invention comprises (A) a support, (B) an optical waveguide formed on the support, (C) an optical fiber guide portion formed on the support for positioning an optical fiber which is to be connected with the optical waveguide, and (D) a cover member which is placed on and adheres to the upper surface of the optical waveguide as an optional component.

Each of the constituent components (A) to (D) will now be described in detail.

[A. Support]

Examples of the support include a silicon wafer, and the like.

[B. Optical Waveguide]

The optical waveguide comprises a core portion, and clad layers which are formed around the core portion and have refractive indices smaller than the refractive index of the core portion.

A typical example of the optical waveguide comprises a lower clad layer formed on the support, a core portion formed on a part of the upper surface of the lower clad layer, and an upper clad layer formed on the lower clad layer to cover the core portion.

In the present invention, a radiation-sensitive polysiloxane composition is used as the material for the optical waveguide.

A radiation-sensitive polysiloxane composition excels other materials used for forming an optical waveguide in weather resistance and scratch resistance.

Preferable examples of the radiation-sensitive polysiloxane composition include a composition comprising the following components (a) to (c) and having a silanol (Si—OH) group content of from 10 to 50 percent based on the total bonds on Si:

(a) at least one type of compound selected from the group consisting of hydrolysates of hydrolyzable silane compounds represented by the following general formula (1), and condensation products of said hydrolysates,
(R¹)ₚ(R²)_{q}Si(X)_{4-p-q} (1)
[In the formula, R¹ is a non-hydrolyzable organic group having 1 to 12 carbon atoms and at least one fluorine atoms; R² is a non-hydrolyzable organic group having 1 to 12 carbon atoms (excepting a group having a fluorine atom); X is a hydrolyzable group; p is 1 or 2; q is 0 or 1.];
(b) a photo-acid generator;
(c) other components such as an organic solvent, an acid diffusion control agent, and the like which are added as optional components.

Here, the term ‘silanol group’ means a hydroxyl group which binds directly to Si, that is, ‘Si—OH’.

When the optical waveguide is formed using the radiation-sensitive polysiloxane composition comprising the above components (a) to (c) (note that the component (c) is an optional component, thus it may not be added), the excellent patterning characteristics upon radiation exposure can be obtained, the low waveguide loss to a light in a broad wavelength range from visible to infrared can be kept stably over a long period of time, and the crack resistance, the heat resistance, and the transparency can be improved.

Each of the components (a) to (c) will now be described in detail.

[Component (a)]

The component (a) is at least one types of compound selected from the group consisting of hydrolysates of hydrolyzable silane compound represented by the following general formula (1), and condensation products of said hydrolysates.
(R¹)ₚ(R²)_{q}Si(X)_{4-p-q} (1)
[In the formula, R¹ is a non-hydrolyzable organic group having 1 to 12 carbon atoms and at least one fluorine atoms; R² is a non-hydrolyzable organic group having 1 to 12 carbon atoms (excepting a group having a fluorine atom); X is a hydrolyzable group; p is 1 or 2; q is 0 or 1.]

The hydrolysate of the hydrolyzable silane compound means not only a product in which an alkoxy group changes into a silanol group by hydrolysis but also a partial condensate in which some of the silanol groups are condensed one another, or an alkoxy group and a silanol group are condensed together.

Preferably, the component (a) has a silanol group content of from 1 to 10 mmol/g.

Generally, the component (a) can be obtained by heating the hydrolyzable silane compound of the above general formula (1), or by heating the mixture of the hydrolyzable silane compound and other hydrolyzable silane compounds. By heating, the hydrolyzable silane compounds are hydrolyzed into the hydrolysates, and in some cases, the hydrolysates are condensed, resulting in the production of the component (a).

[Organic Group R¹ in General Formula (1)]

R¹ in general formula (1) is a non-hydrolyzable organic group having 1 to 12 carbon atoms and at least one fluorine atoms. Here, the term ‘non-hydrolyzable’ means the ability of existing as it is stably under the condition in which the hydrolyzable group X is hydrolyzed. Examples of such non-hydrolyzable organic group include a fluorinated alkyl group, fluorinated aryl group, and the like. Examples of the fluorinated alkyl group include a trifluoromethyl group, trifluoropropyl group, heptadecafluorodecyl group, tridecafluorooctyl group, nonafluorohexyl group, and the like. Examples of the fluorinated aryl group include a pentafluorophenyl group, and the like.

Of these, the fluorinated alkyl group expressed by the formula CₙF₂ₙ₊₁ (CH₂)ₘ-[m is an integer from 1 to 5, n is an integer from 1 to 12, and m+n is an integer from 1 to 12.] is preferred, and a long-chain group having a high fluorine content such as heptadecafluorodecyl group, tridecafluorooctyl group, and nonafluorohexyl group is more preferred. Using such group can improve the patterning characteristics of the optical waveguide formed by photolithography, the crack resistance and the optical characteristics (i.e. low transmission loss) of the optical waveguide.

p in general formula (1) is preferably 1.

[Organic Group R² in General Formula (1)]

R² in general formula (1) is a non-hydrolyzable organic group having 1 to 12 carbon atoms (excepting a group having a fluorine atom). Both or either of a non-polymerizable organic group and a polymerizable organic group can be selected as R².

Here, examples of the non-polymerizable organic group include an alkyl group, aryl group, aralkyl group, deuterated group or halogenated thereof, and the like. These organic groups may be linear, branched, cyclic, or a combination of these.

Examples of the alkyl group include a methyl group, ethyl group, propyl group, butyl group, hexyl group, cyclohexyl group, octyl group, and the like. Preferable examples of the halogen atom include fluorine, chlorine, bromine, iodine, and the like.

Examples of the aryl group include a phenyl group, tolyl group, xylyl group, naphthyl group, biphenyl group, deuterated aryl group, halogenated aryl group, and the like.

Examples of the aralkyl group include a benzyl group, phenylethyl group, and the like.

Also, a group having a heteroatom-containing structural unit can be used as the non-polymerizable organic group. Examples of the structural unit include an ether bond, ester bond, sulfide bond, and the like. When the heteroatom-containing group is used, it is preferred to be non-basic.

It is preferable that the polymerizable organic groups in a molecule include an organic group containing a radical polymerizable functional group and/or a cationic polymerizable functional group. When the above functional group is included, radical polymerization and/or cationic polymerization occur, so that the composition can be cured more effectively.

The cationic polymerizable functional group is preferred to the radical polymerizable functional group, because the component (b) (i.e. a photo-acid generator) initiates curing reactions not only of the silanol group but also of the cationic polymerizable functional group simultaneously.

q in general formula (1) is preferably 0.

[Hydrolyzable Group X in General Formula (1)]

X in general formula (1) is a hydrolyzable group. Generally, the hydrolyzable group is a group which can be hydrolyzed to produce a silanol group or a siloxane condensate when heated with a catalyst and an excess of water in the temperature range of 0 to 150 degree C. for 1 to 10 hours at 1 atmosphere.

Here, examples of the catalyst include an acid catalyst and an alkaline catalyst.

Examples of the acid catalyst include monovalent or multivalent organic acids, monovalent or multivalent inorganic acids, Lewis acids, and the like. Examples of the organic acids include formic acid, acetic acid, oxalic acid, and the like. Examples of the Lewis acids include metal compounds, inorganic salts of Ti, Zr, Al, B or the like, alkoxides, carboxylates, and the like.

Examples of the alkaline catalyst include alkaline metal hydroxides, alkaline earth metal hydroxides, amines, acid salts, basic salts, and the like.

The amount of the catalyst needed for the hydrolysis is preferably 0.001 to 5 mass percent, more preferably 0.002 to 1 mass percent to the whole silane compounds.

Examples of the hydrolyzable group X include a hydrogen atom, alkoxy group having 1 to 12 carbon atoms, halogen atom, amino group, acyloxy group, and the like.

Examples of the alkoxy group having 1 to 12 carbon atoms include a methoxy group, ethoxy group, propoxy group, butoxy group, phenoxybenzyloxy group, methoxyethoxy group, acetoxyethoxy group, 2-(meth)acryloxyethoxy group, 3-(meth)acryloxypropoxy group, 4-(meth)acryloxybutoxy group; epoxy group-containing alkoxy group such as glycidyloxy group, 2-(3,4-epoxycyclohexyl)ethoxy group, and the like; oxycetanyl group-containing alkoxy group such as methyloxycetanylmethoxy group, ethyloxycetanylmethoxy group, and the like; alkoxy group having a six member ring ether group such as oxacyclohexyloxy, and the like.

Examples of the halogen atom include fluorine, chlorine, bromine, iodine, and the like.

[Hydrolyzable Silane Compound Represented by General Formula (1)]

Examples of the hydrolyzable silane compound represented by general formula (1) include trifluoromethyltrimethoxysilane, trifluoromethyltriethoxysilane, 3,3,3-trifluoropropyltrichlorosilane, methyl-3,3,3-trifluoropropyldichlorosilane, dimethoxymethyl-3,3,3-trifluoropropylsilane, 3,3,3-trifluoropropyltrimethoxysilane, 3,3,3-trifluoropropylmethyldichlorosilane, 3,3,4,4,5,5,6,6,6-nonafluorohexyltrichlorosilane, 3,3,4,4,5,5,6,6,6-nonafluorohexylmethyldichlorosilane, 3,3,4,4,5,5,6,6,7,7,8,8,9,9,10,10,10-heptadecafluorodecyltrichlorosilane, 3,3,4,4,5,5,6,6,7,7,8,8,9,9,10,10,10-heptadecafluorodecyltrimethoxysilane, 3,3,4,4,5,5,6,6,7,7,8,8,9,9,10,10,10-heptadecafluorodecyltriethoxysilane, 3,3,4,4,5,5,6,6,7,7,8,8,9,9,10,10,10-heptadecafluorodecylmethyldichlorosilane, 3-heptafluoroisopropoxypropyltriethoxysilane, pentafluorophenylpropyltrimethoxysilane, pentafluorophenylpropyltrichlorosilane, and the like. Of these, 3,3,4,4,5,5,6,6,7,7,8,8,9,9,10,10,10-heptadecafluorodecyltriethoxysilane, 3,3,4,4,5,5,6,6,7,7,8,8,9,9,10,10,10-heptadecafluorodecyltrimethoxysilane, and 3,3,4,4,5,5,6,6,6-nonafluorohexyltrichlorosilane are preferred.

[Examples of Other Hydrolyzable Silane Compounds]

Hydrolyzable silane compounds other than the hydrolyzable silane compound represented by general formula (1) can be used optionally. Examples of such hydrolyzable silane compounds include silane compounds having four hydrolyzable groups such as tetrachlorosilane, tetraminosilane, tetraacetoxysilane, tetramethoxysilane, tetraethoxysilane, tetrabutoxysilane, tetraphenoxysilane, tetrabebzyloxysilane, trimethoxysilane, triethoxysilane, and the like; silane compounds having three hydrolyzable groups such as methyltrichlorosilane, methyltrimethoxysilane, methyltriethoxysilane, methyltributoxysilane, ethyltrimethoxysilane, ethyltriisopropoxysilane, ethyltributoxysilane, butyltrimethoxysilane, phenyltrimethoxysilane, phenyltriethoxysilane, deuterated methyltrimethoxysilane, and the like; silane compounds having two hydrolyzable groups such as dimethyldichlorosilane, dimethyldiaminosilane, dimethyldiacetoxysilane, dimethyldimethoxysilane, diphenyldimethoxysilane, diphenyldiethoxysilane, dibutyldimethoxysilane, and the like.

[Method for Preparing Component (a)]

The method for preparing the component (a) is not limited provided that the silanol group content is within the specific range (i.e. from 10 to 50 percent based on the total bonds on Si). An example of the method includes the following steps 1) to 3). Note that, in the hydrolysate of the hydrolyzable silane compound represented by general formula (1), a part of the hydrolyzable groups may remain unhydrolyzed. In this case, the component (a) is provided as a mixture of the hydrolyzable silane compound and the hydrolysate.

1) Put the hydrolyzable silane compound represented by general formula (1) and the acid catalyst into a vessel equipped with a stirrer.

2) Put an organic solvent into the vessel to obtain a mixed solution while adjusting the viscosity of the solution.

3) Add water into the mixed solution while stirring in air atmosphere and at a temperature below the boiling point of both of the organic solvent and the hydrolyzable silane compound, and then, heat at a temperature of 0 to 150 degree C. for 1 to 24 hours while stirring. Here, while heating and stirring the solution, the mixed solution may be concentrated by distillation, or the organic solvent may be substituted as the need arises.

In the method including the above steps 1) to 3), the hydrolyzable silane compounds other than the hydrolyzable silane compound represented by general formula (1) can be mixed to prepare a siloxane oligomer in order to adjust the refractive index of the finally obtained cured product, the curing property, the viscosity of the composition, and the like. In this case, in the above step (1), the hydrolyzable silane compound represented by general formula (1) and the other hydrolyzable silane compounds may be added and mixed, and then, may be heated to react.

[Preferable Embodiment of Component (a)]

Preferably, the component (a) contains at least one type of structure selected from the group consisting of the following general formulae (2) and (3). 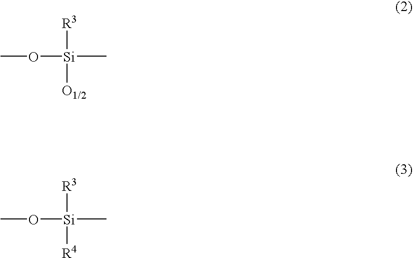
[In the formulae, R³ is a non-hydrolyzable organic group having 1 to 12 carbon atoms and at least one fluorine atoms; R⁴ is a non-hydrolyzable organic group having 1 to 12 carbon atoms and may have a fluorine atom, and may be the same group as R³.]

When the component (a) has the above structure, the crack resistance and the like can be more improved.

More preferably, the component (a) contains at least one type of structure selected from the group consisting of the following general formulae (4) and (5). 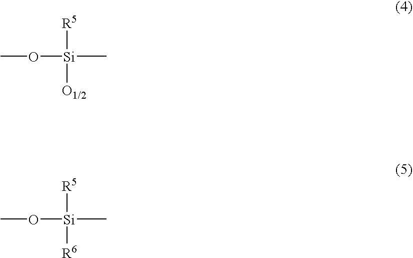
[In the formulae, R⁵ is a phenyl group, or a fluorinated phenyl group; R⁶ is a non-hydrolyzable organic group having 1 to 12 carbon atoms and may have a fluorine atom, and may be the same group as R⁵.]

Examples of the compound having the structure represented by general formula (4) or (5) include a compound having a phenyl group or a fluorinated phenyl group among the hydrolyzable silane compounds represented by general formula (1) and the other hydrolyzable silane compounds. Of these, phenyltrimethoxysilane, phenyltriethoxysilane, and pentafluorophenyltrimethoxysilane are preferably used.

When the component (a) has the above structure, the heat resistance of the optical waveguide, the patterning characteristics, and the like can be more improved.

[Silanol Group Content of Radiation-Sensitive Polysiloxane Composition]

The radiation-sensitive polysiloxane composition has a silanol group content of from 10 to 50 percent, preferably of from 20 to 40 percent based on the total bonds on Si. When the content is within the above range, the patterning characteristics and the transmittance characteristics (i.e. low waveguide loss) can be more improved.

[Component (b)]

The component (b) is a photo-acid generator. Upon irradiation with radiation, the component (b) is decomposed to release an acid active substance which causes the component (a) to cure with radiation.

Here, examples of the radiation include visible light, UV rays, infrared rays, X rays, electron rays, alpha rays, gamma rays, and the like. Of these, UV rays are preferably used, because UV rays have a constant energy level and accelerate the curing speed, and an irradiation apparatus thereof is relatively inexpensive and compact.

Examples of the component (b) include onium salts having the structure represented by the following general formula (6), sulfonic acid derivatives having the structure represented by the following general formula (7), and the like.
[R⁷ₐR⁸_{b}R⁹_{c}R¹⁰_{d}W]^{+m}[M Zₘ₊ₙ]^{-m} (6)
[In the formula, the cation is an onium ion; W is S, Se, Te, P, As, Sb, Bi, O, I, Br, Cl, or —N≡N; R⁷, R⁸, R⁹, and R¹⁰ are the same or different organic groups to one another; a, b, c, and d are independently an integer from 0 to 3; and (a+b+c+d) is equal to the valence of W. M is a metal or a metalloid constituting the center atom of the halogenated complex [M Zₘ₊ₙ], such as B, P, As, Sb, Fe, Sn, Bi, Al, Ca, In, Ti, Zn, Sc, V, Cr, Mn, or Co; Z is a halogen atom such as F, Cl, Br, or the like, or an aryl group; m is a net electric charge of the halogenated complex ion; n is the atomic valence of M]
Qₛ-[S(═O)₂—R¹¹]ₜ (7)
[In general formula (7), Q is a monovalent or a bivalent organic group; R¹¹ is a monovalent organic group having 1 to 12 carbon atoms; s is 0 or 1; t is 1 or 2]
[Onium Salts of General Formula (6)]

Examples of the anion [M Zₘ₊ₙ] in general formula (6) include tetrafluoroborate (B F₄⁻), hexafluorophosphate (P F₆⁻), hexafluoroantimonate (Sb F₆⁻), hexafluoroarsenate (As F₆—), hexachloroantimonate (Sb Cl₆⁻), tetraphenylborate, tetrakis(trifluoromethylphenyl)borate, tetrakis(pentafluoromethylphenyl)borate, and the like.

An anion expressed by the general formula [MZₙOH⁻] can be used instead of the anion [MZₘ₊ₙ] in general formula (6). Also, onium salts having other anions such as perchlorate ion (ClO₄⁻), trifluoromethanesulfate ion (C F₃ SO₄⁻), fluorosulfate ion (F SO₄⁻) toluenesulfate ion, trinitrobenzenesulfate anion, trinitrotoluenesulfate anion, and the like can be used.

A preferable example of the onium salts represented by general formula (6) is aromatic onium salts. Preferable examples of the aromatic onium salts include triarylsulfonium salts, the compound represented by the following general formula (8), diaryliodonium salts represented by the following general formula (9), triaryliodonium salts, and the like. 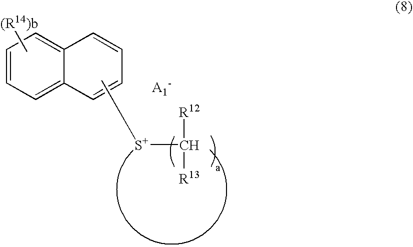
[In the formula, R¹² and R¹³ are each independently a hydrogen or an alkyl group; R¹⁴ is a hydroxyl group or —OR¹⁵ (here, R¹⁵ is a monovalent organic group); a is an integer from 4 to 7; b is an integer from 1 to 7. The bonding site of each substitutent group to a naphthalene ring is not limited.]
[R¹⁶—Ph¹—I⁺—Ph²—R¹⁷][Y⁻] (9)
[In the formula, R¹⁶ and R¹⁷ are the same or different monovalent organic groups; at least one of R¹⁶ and R¹⁷ has an alkyl group having four or more carbon atoms; Ph¹ and Ph² are the same or different aromatic groups; Y⁻ is a monovalent negative ion and is a negative ion selected from the group consisting of a fluoride anion of the third group or the fifth group in the periodic series, ClO₄⁻, and CF₃SO₃⁻.]

Examples of the compound represented by general formula (8) include 4-hydroxy-1-naphthyltetrahydrothiophenium trifluoromethanesulfonate, 4-butoxy-1-naphthyltetrahydrothiophenium trifluoromethanesulfonate, 1-(4,7-dihydroxy)-naphthyltetrahydrothiophenium trifluoromethanesulfonate, 1-(4,7-di-t-butoxy)-naphthyltetrahydrothiophenium trifluoromethanesulfonate, and the like.

Examples of the diaryliodonium salts of general formula (9) include (4-n-decyloxyphenyl)phenyliodoniumhexafluoroantimonate, [4-(2-hydroxy-n-tetradecyloxy)phenyl]phenyliodonium hexafluoroantimonate, [4-(2-hydroxy-n-tetradecyloxy)phenyl]phenyliodonium trifluorosulfonate, [4-(2-hydroxy-n-tetradecyloxy)phenyl]phenyliodonium hexafluorophosphate, [4-(2-hydroxy-n-tetradecyloxy)phenyl]phenyliodonium tetrakis(pentafluorophenyl)borate, bis(4-t-butylphenyl)iodonium hexafluoroantimonate, bis(4-t-butylphenyl)iodonium hexafluorophosphate, bis(4-t-butylphenyl)iodonium trifluorosulfonate, bis(4-t-butylphenyl)iodonium tetrafluoroborate, bis(dodecylphenyl)iodonium hexafluoroantimonate, bis(dodecylphenyl)iodonium tetrafluoroborate, bis(dodecylphenyl)iodonium hexafluorophosphate, bis(dodecylphenyl)iodonium trifluoromethylsulfonate, and the like.

[Sulfonic Acid Derivatives of General Formula (7)]

Examples of the sulfonic acid derivatives represented by general formula (7) include disulfones, disulfonyldiazomethanes, disulfonylmethanes, sulfonylbenzoylmethanes, imidosulfonates, benzoinsulfonates, sulfonates of 1-oxy-2-hydroxy-3-propylalcohol, pyrogalloltrisulfonates, benzylsulfonates, and the like. Of these, imidosulfonates are preferred, and trifluoromethylsulfonate derivatives are especially preferred.

The amount of the component (b) (i.e. photo-acid generator) to be added is not limited, but is preferably 0.01 to 15 mass parts (i.e. parts by weight), more preferably 0.1 to 10 mass parts, per 100 mass parts of the component (a). When the added amount is less than 0.1 mass part, the property of photocuring tends to deteriorate, so that curing speed is too slow. When the added amount is more than 15 mass parts, the weather resistance and the heat resistance of the obtained cured product tend to deteriorate.

[Component (c)]

Components other than the components (a) and (b), such as organic solvents, acid diffusion controllers, reactive diluents, radical generators (i.e. photopolymerization initiators), photosensitizers, metal alkoxides, inorganic fine particles, dehydrating agents, leveling agents, polymerization inhibitors, polymerization aids, wetting agents, surfactants, plasticizers, UV absorbers, antioxidants, antistatic agents, silane coupling agents, polymer additives, and the like, can be added to the radiation-sensitive polysiloxane composition.

The organic solvent and the acid diffusion controller will now be described in detail.

(1) Organic Solvent

By using an organic solvent as a component of the radiation-sensitive polysiloxane composition, it is possible to obtain a composition having improved storage stability and appropriate viscosity, and to form an optical waveguide having a uniform thickness.

Examples of the organic solvent include an ether type organic solvent, an ester type organic solvent, a ketone type organic solvent, a hydrocarbon organic solvent, an alcohol organic solvent, and the like.

Generally, it is preferable to use an organic solvent which has a boiling point of 50 to 200 degree C. under air atmosphere and which can dissolve each component uniformly.

Examples of such organic solvents include aliphatic hydrocarbon solvents, aromatic hydrocarbon solvents, mono alcohol solvents, multiple alcohol solvents, ketone type solvents, ether type solvents, ester type solvents, nitrogen-containing solvents, sulfur-containing solvents, and the like. Only one type or at least two types of such organic solvents can be used in the composition.

Preferable examples of the organic solvent include alcohols, ketones, and the like in view of the improvement of the storage stability of the composition. More preferable examples include propylene glycol monomethyl ether, ethyl lactate, methyl isobutyl ketone, methyl amyl ketone, toluene, xylene, methanol, and the like.

The organic solvent is selected in view of the applying method of the composition. For example, when a spin coating method is used to easily obtain a thin film having a uniform thickness, glycol ethers such as ethylene glycol monoethyl ether, propylene glycol monomethyl ether; ethylene glycol alkyl ether acetates such as ethyl cellosolve acetate, propylene glycol methyl ether acetate, propylene glycol ethyl ether acetate; esters such as ethyl lactate, 2-hydroxypropionic acid ethyl ester; diethylene glycols such as diethylene glycol monomethyl ether, diethylene glycol dimethyl ether, diethylene glycol ethyl methyl ether; and ketones such as methyl isobutyl ketone, 2-heptanone, cyclohexanone, methyl amyl ketone can be used preferably. Of these, ethyl cellosolve acetate, irradiation or heating is preferred.

Examples of such nitrogen-containing organic compound include a compound represented by the following general formula (10).
NR¹⁸R¹⁹R²⁰ (10)
[In the formula, R¹⁸, R¹⁹, and R²⁰ are each independently a hydrogen atom, substituted or unsubstituted alkyl group, substituted or unsubstituted aryl group, or substituted or unsubstituted aralkyl group.]

Other examples of the nitrogen-containing organic compound include a diamino compound having two nitrogen atoms in a molecule, diamino polymer having at least three nitrogen atoms, amide group-containing compound, urea compound, nitrogen-containing heterocyclic compound, and the like.

Examples of the nitrogen-containing organic compound include monoalkylamines such as n-hexylamine, n-heptylamine, n-octylamine, n-nonylamine, n-decylamine; dialkylamines such as di-n-butylamine, di-n-pentylamine, di-n-hexylamine, di-n-heptylamine, di-n-octylamine, di-n-nonylamine, di-n-decylamine; trialkylamines such as triethylamine, tri-n-propylamine, tri-n-butylamine, tri-n-pentylamine, tri-n-hexylamine, tri-n-heptylamine, tri-n-octylamine, tri-n-nonylamine, tri-n-decylamine; and aromatic amines such as aniline, N-methylaniline, N,N-dimethylaniline, 2-methylaniline, 3-methylaniline, 4-methylaniline, 4-nitroaniline, diphenylamine, triphenylamine, 1-naphthylamine; alkanolamines such as ethanolamine, diethanolamine, triethanolamine.

Only one type or at least two types of the acid diffusion controllers can be used in the composition.

The amount of the acid diffusion controller to be added is preferably 0.001 to 15 mass parts, more preferably 0.005 to 5 mass parts, per 100 mass parts of the component (a). When the added amount is less than 0.001 mass part, sometimes the optical waveguide is insufficiently patterned or exhibits poor dimensional reproducibility depending on process conditions. When the added amount is more than 15 mass parts, the property of photocuring of the component (a) sometimes deteriorates.

[Use as Material for Optical Waveguide]

The radiation-sensitive polysiloxane composition can be used as a lower clad layer composition, a core composition, and an upper clad layer composition for forming the lower clad layer, the core portion, and the upper clad layer respectively, wherein the lower clad layer, the core portion, and the upper clad layer constitute the optical waveguide.

As the materials of the lower clad layer composition, the core composition, and the upper clad layer composition, compositions having different components can be used so that the relationship of the refractive indices of respective portions (i.e. clad layers and core portion) finally obtained satisfy the condition required for the optical waveguide. Note that the lower clad layer composition and the upper clad layer composition are preferably the same in order to manufacture the optical waveguide more easily and efficiently.

For example, it is preferable to select two compositions which have appropriately different refractive indices and to use one composition having higher refractive index as the core composition and the other one having lower refractive index as the lower clad layer composition and the upper clad layer composition.

The viscosity of the radiation-sensitive polysiloxane composition is preferably 5 to 5,000 mPa·s, more preferably 10 to 1,000 mPa·s at 25 degree C. When the viscosity is more than 5,000 mPa·s, it is sometimes difficult to form a uniform film. The viscosity can be adjusted as appropriate by controlling the added amount of the organic solvent.

[C. Optical Fiber Guide Portion]

As the material for the optical fiber guide portion, the same or a different radiation-sensitive composition as/from the material of the optical waveguide is used.

Examples of the radiation-sensitive composition different from the material of the optical waveguide include a radiation-sensitive composition containing an ethylenically unsaturated group-containing compound, and a radiation-sensitive polysiloxane composition other than the material of the optical waveguide.

An example of the radiation-sensitive composition containing an ethylenically unsaturated group-containing compound is a radiation-sensitive composition comprising (A) a copolymer obtained by copolymerizing a radical polymerizable compound having a carboxyl group and other radical polymerizable compounds, (B) a compound having at least two polymerizable reactive groups in its molecule, and (C) a photopolymerization initiator.

[Copolymer (A)]

The copolymer (A) can be obtained by radical-copolymerizing a radical polymerizable compound having a carboxyl group and other radical polymerizable compounds in a solvent.

Examples of the radical polymerizable compound having a carboxyl group include a mono-carboxylic acid such as acrylic acid, methacrylic acid, and crotonic acid; a di-carboxylic acid such as maleic acid, fumaric acid, citraconic acid, mesaconic acid, and itaconic acid; a methacrylic acid derivative containing a carboxyl group and ester bond such as 2-succinoloyl ethyl methacrylate, 2-maleinoloyl ethyl methacrylate, and 2-hexahydrophthaloylethyl methacrylate. Of these, acrylic acid, methacrylic acid, and 2-hexahydrophthaloylethyl methacrylate are preferred, and acrylic acid and methacrylic acid are especially preferred.

The copolymer (A) has a content of the radical polymerizable compound having a carboxyl group of 3 to 50 mass percent, preferably of 5 of 40 mass percent. When the content is out of the above range, the cured product of the radiation-sensitive composition tends to exhibit low dimensional accuracy.

The other radical polymerizable compounds are used for controlling the mechanical properties, the glass transition temperature, and the refractive index. Preferred examples of the compound include (meth)acrylic acid alkyl esters, (meth)acrylic acid aryl esters, dicarboxylic acid diesters, aromatic vinyls, conjugated diolefins, nitrile group-containing polymerizable compounds, chlorine-containing polymerizable compounds, amide bond-containing polymerizable compounds, vinyl fatty acids, and the like. Examples of such compound include a (meth)acrylate alkyl ester such as methyl(meth)acrylate, ethyl(meth)acrylate, isopropyl(meth)acrylate, n-butyl(meth)acrylate, sec-butyl (meth)acrylate, t-butyl(meth)acrylate, cyclohexyl (meth)acrylate, 2-methylcyclohexyl(meth)acrylate, dicyclopentanyloxyethyl(meth)acrylate, isobornyl(meth)acrylate, and dicyclopentanyl(meth)acrylate; (meth)acrylate aryl ester such as phenyl(meth)acrylate, and benzyl(meth)acrylate; dicarboxylic diester such as diethyl maleate, diethyl fumarate, and diethyl itaconate; aromatic vinyl such as styrene, α-methylstyrene, m-methylstyrene, p-methylstyrene, vinyl toluene, and p-methoxystyrene; conjugated diolefin such as 1,3-butadiene, isoprene, and 1,4-dimethylbutadiene; nitrile group-containing polymerizable compound such as acrylonitrile, and methacrylonitrile; chlorine-containing polymerizable compound such as vinyl chloride, and vinylidene chloride; amide bond-containing polymerizable compound such as acrylamide, and methacrylamide; vinyl fatty acid such as vinyl acetate. Of these, methyl(meth)acrylate, n-butyl(meth)acrylate, styrene, α-methylstyrene, dicyclopentanyloxyethyl(meth)acrylate, isobornyl(meth)acrylate, and dicyclopentanyl(meth)acrylate can be preferably used.

The copolymer (A) has a content of the other radical polymerizable compounds of 50 to 97 mass percent, preferably of 60 to 95 mass percent.

Examples of the polymerization solvent used when the copolymer (A) is copolymerized include alcohols such as methanol, ethanol, ethylene glycol, diethyleneglycol, propylene glycol; cyclic ethers such as tetrahydrofuran, and dioxane; alkyl ethers of polyhydric alcohols such as ethylene glycol monomethyl ether, ethylene glycol monoethyl ether, ethylene glycol dimethyl ether, ethylene glycol diethyl ether, diethylene glycol monomethyl ether, diethylene glycol monoethyl ether, diethylene glycol dimethyl ether, diethylene glycol diethyl ether, diethylene glycol ethyl methyl ether, propylene glycol monomethyl ether, and propylene glycol monoethyl ether; alkyl ether acetates of polyhydric alcohols such as ethylene glycol ethyl ether acetate, diethylene glycol ethyl ether acetate, and propylene glycol ethyl ether acetate; aromatic hydrocarbons such as toluene, and xylene; ketones such as acetone, methyl ethyl ketone, methyl isobutyl ketone, cyclohexanone, 4-hydroxy-4-methyl-2-pentanone, and diacetone alcohol; esters such as ethyl acetate, butyl acetate, ethyl lactate, 2-hydroxy-ethyl propionate, 2-hydroxy-2-methyl-ethyl propionate, ethoxy ethyl acetate, hydroxy ethyl acetate, 2-hydroxy-3-methyl-methyl butanonate, 3-methoxy-methyl propionate, 3-methoxy-ethyl propionate, 3-ethoxy-ethyl propionate, and 3-ethoxy-methyl propionate.

Of these, cyclic ethers, alkyl ethers of polyhydric alcohols, alkyl ether acetates of polyhydric alcohols, ketones, and esters are preferably used.

Examples of the polymerization catalyst include an azo compound such as 2,2′-azobisisobutyronitrile, 2,2′-azobis-(2,4-dimethylvaleronitrile), and 2,2′-azobis-(4-methoxy-2′-dimethylvaleronitrile); organic peroxide such as benzoyl peroxide, lauroyl peroxide, t-butyl peroxypivalate, and 1,1′-bis-(t-butylperoxy)cyclohexane; and hydrogen peroxide. When the peroxide is used as a radical polymerization initiator, the peroxide may be used together with a reductant to use as a redox type initiator.

Preferably, the copolymer (A) has a glass transition temperature of 20 to 150 degree C. The glass transition temperature is defined using a differential scanning calorimeter (DSC). When the temperature is less than 20 degree C., tackiness may cause disadvantages when the copolymer (A) is laminated on a support. When the temperature is more than 150 degree C., the cured product of the radiation-sensitive composition sometimes becomes too hard and fragile.

[Compound (B)]

The compound (B) is a compound having at least two polymerizable reactive groups in its molecule. Examples of the polymerizable reactive group include an ethylenically unsaturated group, and cyclic ether.

Examples of the compound (B) include a compound having at least two ethylenically unsaturated groups, and a compound having at least two cyclic ethers. Of these, the compound having at least two ethylenically unsaturated groups is preferred.

(1) Compound Having at Least Two Ethylenically Unsaturated Groups

Examples of the compound having at least two ethylenically unsaturated groups include a compound having at least two (meth)acryloyl or vinyl groups.

Examples of the compound having two (meth)acryloyl groups include ethylene glycol di(meth)acrylate, tetraethylene glycol di(meth)acrylate, polyethylene glycol di(meth)acrylate, 1,4-butanediol di(meth)acrylate, 1,6-hexanediol di(meth)acrylate, neopentyl glycol di(meth)acrylate, tris(2-hydroxyethyl)isocyanurate di(meth)acrylate, bis(hydroxymethyl)tricyclodecane di(meth)acrylate, (meth)acrylate of a diol which is a ethylene oxide or propylene oxide adduct of bisphenol A, (meth)acrylate of a diol which is a ethylene oxide or propylene oxide adduct of hydrogenated bisphenol A, epoxy(meth)acrylate which is a (meth)acrylate adduct of diglycidyl ether of bisphenol A, diacrylate of polyoxyalkylene bisphenol A, and the like.

Examples of the compound containing three (meth)acryloyl groups include a compound wherein at least three moles of (meth)acrylic acids are ester-linked to a polyhydric alcohol having at least three hydroxyl groups, such as trimethylolpropane tri(meth)acrylate, pentaerythritol tri(meth)acrylate, trimethylolpropane trioxyethyl(meth)acrylate, tris(2-hydroxyethyl)isocyanurate tri(meth)acrylate, dipentaerythritol hexa(meth)acrylate, and the like.

Also, a polyether acrylic oligomer, a polyester acrylic oligomer, and a polyurethane acrylic oligomer, wherein these oligomers have a polyether, polyester, or polyurethane backbone in their main chain respectively, and a polyepoxy acrylic oligomer can be used.

(2) Compound Having at Least Two Cyclic Ethers in its Molecule

Examples of the compound having at least two cyclic ethers include a compound which is selected from an oxirane compound, oxetane compound, oxolane compound and the like and which has at least two cyclic ethers in its molecule.

Examples of the oxirane compound include 3,4-epoxy cyclohexylmethyl-3′,4′-epoxycyclohexanecarboxylate, 2-(3,4-epoxy cyclohexyl-5,5-spiro-3,4-epoxy)cyclohexane-(meth)-dioxane, bis(3,4-epoxycyclohexylmethyl)adipate, vinylcyclohexene oxide, 4-vinylepoxycyclohexane, bis(3,4-epoxy-6-methylcyclohexylmethyl)adipate, 3,4-epoxy-6-methylcyclohexyl-3′,4′-epoxy-6′-methylcyclohexane carboxylate, methylenebis(3,4-epoxycyclohexane), dicyclopentadiene diepoxide, di(3,4-epoxycyclohexylmethyl) ether of ethyleneglycol, ethylenebis(3,4-epoxycyclohexanecarboxylate), epoxidized tetrabenzyl alcohol, lactone modified 3,4-epoxycyclohexylmethyl-3′,4′-epoxycyclohexanecarboxylate, lactone modified epoxidized tetrahydrobenzyl alcohol, cyclohexene oxide, bisphenol A diglycidyl ether, bisphenol F diglycidyl ether, bisphenol S diglycidyl ether, hydrogenated bisphenol A diglycidyl ether, hydrogenated bisphenol F diglycidyl ether, hydrogenated bisphenol AD diglycidyl ether, brominated bisphenol A diglycidyl ether, brominated bisphenol F diglycidyl ether, brominated bisphenol S diglycidyl ether, epoxy novolac resin, 1,4-butanediol diglycidyl ether, 1,6-hexanediol diglycidyl ether, glycerine triglycidyl ether, trimethylolpropane triglycidyl ether, polyethylene glycol diglycidyl ether, polypropylene glycol diglycidyl ethers; polyglycidyl ethers of polyether polyols obtained by the addition of one or more alkylene oxides to an aliphatic polyhydric alcohol such as ethylene glycol, propylene glycol, glycerine; diglycidyl esters of long chain aliphatic dibasic acids; monoglycidyl ethers of higher fatty alcohols; monoglycidyl ethers of phenol, cresol, butyl phenol, or polyether alcohols obtained by adding alkylene oxides thereto; glycidyl esters of higher fatty acids; epoxidized soybean oil; epoxidized butyl stearate, epoxidized octyl stearate, epoxidized flaxseed oil, and the like.

Examples of the oxetane compound include 3,7-bis(3-oxetanyl)-5-oxa-nonane, 3,3′-(1,3-(2-methylenyl)propanediylbis(oxymethylene))bis-(3-ethyloxetane), 1,4-bis[(3-ethyl-3-oxetanylmethoxy)methyl]benzene, 1,2-bis[(3-ethyl-3-oxetanylmethoxy)methyl]ethane, 1,3-bis[(3-ethyl-3-oxetanylmethoxy)methyl]propane, ethylene glycol bis(3-ethyl-3-oxetanylmethyl)ether, dicyclopentenylbis(3-ethyl-3-oxetanylmethyl)ether, triethylene glycol bis(3-ethyl-3-oxetanylmethyl)ether, tetraethylene glycol bis(3-ethyl-3-oxetanylmethyl)ether, tricyclodecanediyldimethylene(3-ethyl-3-oxetanylmethyl)ether, trimethylolpropane tris(3-ethyl-3-oxetanylmethyl)ether, 1,4-bis(3-ethyl-3-oxetanylmethoxy)butane, 1,6-bis(3-ethyl-3-oxetanylmethoxy)hexane, pentaerythritol tris(3-ethyl-3-oxetanylmethyl)ether, pentaerythritol tetrakis(3-ethyl-3-oxetanylmethyl)ether, and the like.

(3) Other Compounds

Examples of the compound other than the above components (1) and (2) include a compound having at least one ethylenically unsaturated groups and at least one cyclic ethers as reactive groups.

Examples of such compounds include glycidyl(meth)acrylate, vinylcyclohexene oxide, 4-vinylepoxycyclohexane, 3,4-epoxycyclohexylmethyl(meth)acrylate, and the like.

The amount of the compound (B) to be added is preferably 30 to 150 mass parts, more preferably 50 to 130 mass parts, per 100 mass parts of the copolymer (A). When the added amount is less than 30 mass parts, the cured product of the composition sometimes has poor dimensional accuracy. When the added amount is more than 150 mass parts, the compound (B) has poor compatibility with the copolymer (A), so that the surface of the cured product of the composition sometimes becomes rough.

[Photo-Polymerization Initiator (C)]

Examples of the photopolymerization initiator include a photo radical polymerization initiator which is decomposed by irradiation to generate a radical, and a photocationic polymerization initiator which generates a cation by irradiation.

Examples of the photo radical polymerization initiator include acetophenone, acetophenone benzyl ketal, 1-hydroxycyclohexyl phenyl ketone, 2,2-dimethoxy-2-phenylacetophenone, xanthone, fluorenone, benzoic aldehyde, fluorene, anthraquinone, triphenylamine, carbazole, 3-methylacetophenone, 4-chlorobenzophenone, 4,4′-dimethoxybenzophenone, 4,4′-diaminobenzophenone, Michler's ketone, benzoin propyl ether, benzoin ethyl ether, benzyl dimethyl ketal, 1-(4-isopropylphenyl)-2-hydroxy-2-methylpropane-1-one, 2-hydroxy-2-methyl-1-phenylpropane-1-one, thioxanthone, diethylthioxanthone, 2-isopropylthioxanthone, 2-chlorothioxanthone, 2-methyl-1-[4-(methylthio)phenyl]-2-morpholino-propane-1-one, 2,4,6-trimethylbenzoyldiphenylphosphine oxide, bis-(2,6-dimethoxybenzoyl)-2,4,4-trimethylpentylphosphine oxide, and the like.

As the photo cationic polymerization initiator, the same photo-acid generator as the above component (b) (i.e. a photo-acid generator) for the optical waveguide can be used.

The radiation-sensitive composition has a content of the photopolymerization initiator preferably of 0.1 to 10 mass percent (i.e. weight percent), more preferably of 0.2 to 5 mass percent. When the content is less than 0.1 mass percent, the composition is sometimes cured slowly, resulting in a decreased manufacturing efficiency. When the content is more than 10 mass percent, mechanical properties of the composition sometimes deteriorate.

[Other Components]

Photosensitizers, antioxidants, ultraviolet [UV] absorbers, light stabilizers, silane coupling agents, coating surface improvers, thermal polymerization inhibitors, leveling agents, surfactants, coloring agents, preservation stabilizers, plasticizers, lubricants, fillers, inorganic particles, antioxidants, wetting agents, antistatic agents, and the like can be added to the radiation-sensitive composition for forming the optical fiber guide portion as the need arises.

[D. Cover Member]

The cover member is a plate-like member to be fixed to the upper surface of the optical waveguide via an adhesive.

Any material having a low moisture permeability can be used as the material for the cover member. However, preferable examples of the material include glass, quartz, and the like in view of low coefficient of linear expansion and strength.

There are no particular limitations on the thickness of the cover member, but the cover member generally has a thickness of 50 to 1,000 μm.

As the adhesive, a photocurable adhesive is preferably used in view of the manufacturing efficiency of the optical waveguide and the curing properties at room temperature. Examples of the photocurable adhesive include an UV curable acrylic adhesive, UV curable epoxy adhesive, UV curable silicone adhesive, and the like. The photocurable adhesives are available as commercial products under the trade names of NOA60, NOA65, NOA81 (manufactured by Norland Products Inc); OG14-4, OG146 (manufactured by EPO-TEK); three bond 3160, three bond 3170B (manufactured by Three Bond Co., Ltd.); AT6001, GA700L, AT3925M, AT9575M (manufactured by NTT Advanced Technology Corporation); ELC2710. ELC2500clear (manufactured by Electro-Lite Corporation).

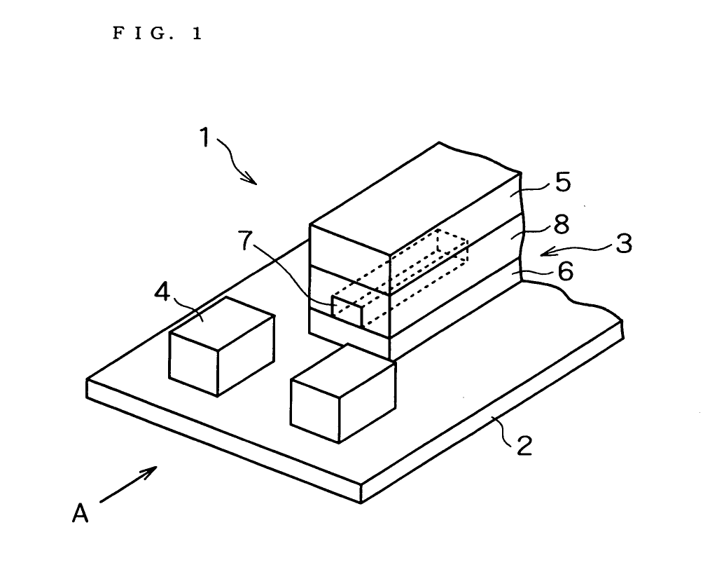

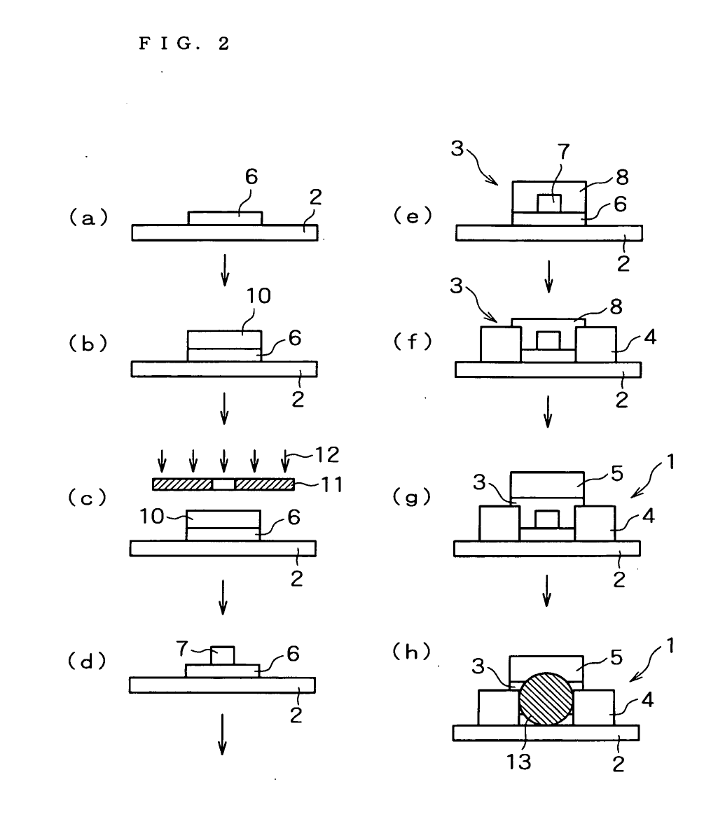

An example of the method for manufacturing an optical waveguide chip of the present invention will now be described. FIG. 1 is a perspective view illustrating an example of the optical waveguide chip manufactured by the method of the present invention. FIG. 2 is a flow diagram illustrating an example of the method for manufacturing the optical waveguide chip shown in FIG. 1. Note that FIG. 2 illustrates the optical waveguide chip seen in the direction of arrow A in FIG. 1.

In FIG. 1, the optical waveguide chip 1 is composed of a support 2 such as silicon wafer, an optical waveguide 3 formed on the support 2, an optical fiber guide portion 4,4 formed on the support 2 and spaced apart from the optical waveguide 3, and a cover member (a glass plate) 5 fixed to the upper surface of the optical waveguide 3.

The optical waveguide 3 comprises a lower clad layer 6, a core portion 7 formed on a part of the upper surface of the lower clad layer 6, and an upper clad layer 8 formed on the lower clad layer 6 to cover the core portion 7. Note that the lower clad layer 6 and the upper clad layer 8 are made of the same material and become one clad layer formed around the core portion 7 after the optical waveguide 3 is completely formed.

An example of the manufacturing method of an optical waveguide chip of the present invention is as follows.

[Formation of Lower Clad Layer]

In FIG. 2, the radiation-sensitive polysiloxane composition for the lower clad layer is applied onto the upper surface of the support 2 such as a silicon wafer, and then, is dried or prebaked (i.e. heated as pretreatment) to form a thin film for the lower clad layer.

Here, as a method of applying the radiation-sensitive polysiloxane composition, spin coating method is preferably used, because a thin film having a uniform thickness can be obtained.

Next, the thin film for the lower clad layer is irradiated with radiation (i.e. light) via a photo-mask having a prescribed pattern to cure the material of the thin film partially.

There are no particular limitations on the type of light used for irradiation, but a light ranging from ultraviolet or visible band having a wavelength of 200 to 450 nm is usually used, and a light containing ultraviolet rays having a wavelength of 365 nm is preferably used. The target (i.e. the radiation-sensitive polysiloxane composition) is irradiated in a prescribed pattern at a light intensity of 1 to 1,000 mW/cm² at a wavelength of 200 to 450 nm, and at a light dose of 0.01 to 5,000 mJ/cm², preferably of 0.1 to 1,000 mJ/cm².

After the irradiation, by developing non-irradiated portion (i.e. unexposed portion) with a developer, the uncured and unnecessary portion is removed to form the lower clad layer 6 which is a patterned and cured film on the support 2 (see FIG. 2 (a)).

A solution obtained by diluting a basic substance with a solvent can be used as the developer.

Examples of the basic substance include sodium hydroxide, potassium hydroxide, sodium carbonate, sodium silicate, sodium metasilicate, ammonia, ethylamine, n-propylamine, diethylamine, di-n-propylamine, triethylamine, methyldiethylamine, ethanolamine, N-methylethanolamine, N,N-dimethylethanolamine, triethanolamine, tetramethylammonium hydroxide, tetraethylammonium hydroxide, tetrabutylammonium hydroxide, choline, pyrrole, piperidine, 1,8-diazabicyclo[5.4.0]-7-undecene, 1,5-diazabicyclo[4.3.0]-5-nonane, and the like.

Examples of the solvent include water, methanol, ethanol, propyl alcohol, butanol, octanol, propylene glycolmonomethyl ether, propylene glycolmonoethyl ether, N-methylpyrrolidone, formamide, N,N-dimethylformamide, N,N-dimethylacetamide, and the like.

The developer usually has a content of the basic substance of 0.05 to 25 mass percent, preferably of 1.0 to 10.0 mass percent.

Generally, the developing is carried out for 30 to 600 seconds. Developing methods that can be employed include puddle developing, dipping, shower developing, and the like.

When an organic solvent is used as the solvent for the developer, direct air-drying is performed to evaporate the organic solvent, and a patterned thin film is formed.

When water (or an aqueous solution) is used as the solvent for the developer, for example, washing is performed with running water for 30 to 90 seconds, followed by drying with compressed air or compressed nitrogen to remove the moisture, and a patterned thin film is formed.

It is preferable to perform a heating treatment after exposure in order to promote the curing of the exposed portion. The heating is performed under various heating conditions depending on the makeup (i.e. composition) of the radiation-sensitive polysiloxane composition or the types of the additives, but usually at a temperature of 30 to 200 degree C., preferably of 50 to 150 degree C.

In addition to the heating treatment after exposure, it is preferable to perform post-baking (i.e. heating as post-treatment) to cure the entire thin film sufficiently. The heating is performed under various heating conditions depending on the makeup of the radiation-sensitive polysiloxane composition or the types of the additives, but usually at a temperature of 30 to 400 degree C., preferably of 50 to 300 degree C. The heating is usually performed for 5 minutes to 72 hours, although there are no particular limitations on the heating time.

The method of applying the radiation-sensitive polysiloxane composition, the amount and method of irradiation with light (i.e. energy ray) in the formation of the lower clad layer can also be applied to those in the formation of the core portion, the upper clad layer, or the optical fiber guide portion described below.

[Formation of Core Portion]

The composition 10 for the core (i.e. the radiation-sensitive polysiloxane composition having a refractive index higher than the refractive indices of the clad layers) is applied onto the upper surface of the lower clad layer 6, and then, dried and optionally pre-baked, to form a thin film for the core portion (see FIG. 2 (b)).

After that, the upper surface of the thin film for the core portion is irradiated with radiation via a photo-mask having a prescribed pattern (see FIG. 2 (c)). After the irradiation, the unnecessary and uncured portion is developed with a developer to be removed, and the core portion 7 composed of just the exposed portion (i.e. cured portion) is formed (see FIG. 2 (d)).

Next, just in the same way as the lower clad layer 6, post-bake is performed, for example, at a temperature of 30 to 400 degree C. for 5 to 600 minutes using a hotplate, oven, or other heating means to obtain the well-cured core portion 7.

[Formation of Upper Clad Layer]

The radiation-sensitive polysiloxane composition for the upper clad layer is applied onto the cured product composed of the core portion 7 and the lower clad layer 6, and then, dried and optionally pre-baked, to form a thin film for the upper clad layer.

Next, the upper surface of the thin film for the upper clad layer is irradiated with radiation via a photo-mask having a prescribed pattern. After the irradiation, the unnecessary and uncured portion is developed with a developer to be removed, and the upper clad layer 8 composed of just the exposed portion (i.e. cured portion) is formed (see FIG. 2 (e)).

Moreover, the upper clad layer 8 is preferably subjected to the same heat treatment (i.e. post-bake) as the lower clad layer 6. Performing this heat treatment (i.e. post-bake) yields the upper clad layer 8 with excellent hardness and excellent heat resistance.

[Formation of Optical Fiber Guide Portion]

The radiation-sensitive composition (for example, a radiation-sensitive polysiloxane composition without adjusting the refractive index, or a radiation-sensitive (meth)acrylate composition) is applied onto the support 2 on which the optical waveguide 3 has been formed, and then, dried and optionally pre-baked, to form a thin film for forming the optical fiber guide portion.

Next, the upper surface of the thin film for the optical fiber guide portion is irradiated with radiation via a photo-mask having a prescribed pattern. After the irradiation, the unnecessary and uncured portion is developed with a developer to be removed, and the optical fiber guide portion 4, 4 composed of just the exposed portion (i.e. cured portion) is formed (see FIG. 2 (f)). Next, by performing the heating treatment (post-bake) at a prescribed temperature (for example, 30 to 400 degree C.) for a prescribed time (for example, 5 to 600 minutes) using heating means such as a hotplate, the well-cured optical fiber guide portion 4,4 can be obtained.

The optical fiber guide portion 4, 4 is a pair of molded products which are formed at prescribed position on the support 2 to have a suitable distance from the optical waveguide 3 and which are apart from each other. By setting the optical fiber 13 in the space between the molded products (see FIG. 2 (h)), the optical axis of the optical fiber 13 can be aligned with the optical axis of the core portion 7. In this case, the optical fiber 13 can be fixed by adhering the optical fiber 13 to the optical fiber guide portion 4, 4 using a photo-curable adhesive (for example, UV adhesive). In this manner, the optical fiber 13 can be fixed at low cost and in a short time in the present invention.

The optical fiber guide portion 4, 4 can be formed with the optical waveguide 3 in one body.

The length of the space between the optical fiber guide portion 4, 4 and the height of the core portion 7 are determined depending on the diameter of the optical fiber to be connected with the optical waveguide 3.

The optical waveguide chip obtained by the method of the present invention is especially suitable for use of connection with a single-mode optical fiber. As the core of the single-mode optical fiber has a small diameter of about 10 μm, which is one-fifth of the diameter of a multi-mode optical fiber, the axes can be precisely aligned by using the optical waveguide chip obtained by the method of the present invention.

[Fixing of Cover Member]

After the formation of the optical fiber guide portion 4, 4, the cover member 5 such as a glass plate is fixed to the upper surface of the optical waveguide 3 via an adhesive to form the optical waveguide chip 1 (see FIG. 2 (g)). The optical waveguide chip 1 is used with the optical fiber 13 set in the space between the optical fiber guide portion 4, 4 (see FIG. 2 (h)).

Note that, in the manufacture of the optical waveguide chip 1, the steps of the method for manufacturing the optical waveguide chip is not necessarily fixed in the order described above. For example, it is possible to form the optical fiber guide portion 4, 4 on the support at first, and then, form the optical waveguide 3 and finally fix the cover member 5.

### EXAMPLES

The present invention will now be described with reference to the following Examples.

[1. Preparation of Radiation-Sensitive Polysiloxane Composition for Optical Waveguide]

(1) Preparation of Clad Layer Composition

[Composition No. 1]

2.97 g of methyltrimethoxysilane, 29.01 g of phenyltrimethoxysilane, 25.64 g of 3,3,4,4,5,5,6,6,7,7,8,8,9,9,10,10, 10-heptadecafluorodecyltriethoxysilane, 31.00 g of 1-methoxy-2-propanol, and 0.04 g of oxalic acid were put into a flask equipped with a stirrer and a reflux tube, and stirred, and then, the solution was heated to a temperature of 60 degree C. Next, after adding 11.3 g of distillated water to the solution, the solution was stirred for 6 hours at a temperature of 120 degree C. This eventually yields 1-methoxy-2-propanol solution whose solids content was adjusted to 70 mass percent. This solution shall be referred to as “siloxane oligomer solution 1”.

By adding 0.06 g of SP172 (manufactured by ADEKA CORPORATION) as a photo-acid generator and 35.0 g of 1-methoxy-2-propanol as an organic solvent to 92.8 g (including solid and organic solvent) of the siloxane oligomer solution 1 and mixing them uniformly, “composition No. 1” was obtained.

The silanol group content of the “composition No. 1” was calculated to be 30% in the following manner.

(Calculating Method of the Silanol Group Content)

The composition No. 1 was diluted with deuterated chloroform as a solvent for NMR-measuring, and the silanol group content was measured using Si-NMR. Specifically, several types of silane components having different substitutional groups or bonding groups presenting in a range of −120 ppm to 60 ppm were peak separated using a curve fitting, and a mole percentage of each component was calculated from area ratio of the peak. By multiplying the mole percentage by the number of silanol group in the each component, the silanol group content (by percentage) in all bonding groups on Si was calculated.

| | mol % | number of silanol group |
|---|---|---|
| Peak 1: R—Si(OH)₃ | a | 3 |
| Peak 2: R—Si(OH)₂(OSi) | b | 2 |
| Peak 3: R—Si(OH)(OSi)₂ | c | 1 |
| Peak 4: R—Si(OSi)₃ | d | 0 |

The silanol group content (by percentage) in all bonding groups on Si=(3a+2b+c)×100/[4×(a+b+c+d)]
[Composition No. 2]

450 g of methyl methacrylate, 50 g of methacryloxypropyltrimethoxysilane, 600 g of propylene glycol monomethyl ether, and 35 g of 2,2′-azobis-(2,4-dimethylvaleronitrile) were put into a vessel equipped with a stirrer, and the system was then purged with nitrogen. The temperature inside the vessel was then set at 70 degree C., and stirring was carried out for 6 hours. Finally a propylene glycol monomethyl ether solution containing acrylic polymer with a solid content of 45 mass percent was obtained. This solution shall be referred to as “acrylic polymer solution 1”.

133.33 g of acrylic polymer solution 1, 231.36 g of methyltrimethoxysilane, 193.48 g of phenyltrimethoxysilane, 108.48 g of distillated water, and 0.30 g of oxalic acid were put into a vessel equipped with a stirrer, then heated while stirring for 6 hours at a temperature of 60 degree C., thus hydrolyzing the acrylic polymer solution 1, the methyltrimethoxysilane, and the phenyltrimethoxysilane.

Next, propylene glycol monomethyl ether was added into the vessel, and then the methanol produced through the hydrolysis was removed using an evaporator. Finally, a propylene glycol monomethyl ether solution containing polysiloxane with a solid content of 45 mass percent was obtained. 0.2 g of SP172 as a photo-acid generator was added to the solution, and mixing to homogeneity was carried out, thus obtaining “Composition No. 2”.

(2) Preparation of Composition for Forming Core Portion [Composition No. 3]

30.79 g of phenyltrimethoxysilane, 22.64 g of 3,3,4,4,5,5,6, 6,7,7,8,8,9,9,10,10,10-heptadecafluorodecyltriethoxysilane, 4.62 g of tetraethoxysilane, 29.93 g of 1-methoxy-2-propanol, and 0.04 g of oxalic acid were put into a flask equipped with a stirrer and a reflux tube, and stirred, and then, the solution was heated to a temperature of 60 degree C. Next, 11.98 g of distillated water was added to the solution, and the solution was then stirred for 6 hours at a temperature of 120 degree C. Finally, a 1-methoxy-2-propanol solution with a solid content made to be 65 mass percent was obtained. This solution shall be referred to as “siloxane oligomer solution 3”.

0.32 g of 1-(4,7-di-t-butoxy)-naphthyltetrahydrothiophenium trifluoromethanesulfonate as a photo-acid generator and 39.5 g of 1-methoxy-2-propanol as an organic solvent were added to 92.6 g (including solid and organic solvent) of the siloxane oligomer solution 3, and mixing to homogeneity was carried out, thus obtaining “Composition No. 3”.

The silanol group content of the “composition No. 3” was calculated to be 29% in the same manner as described above in the “Composition No. 1”.

[Composition No. 4]

76.9 g of phenyltrimethoxysilane, 101.7 g of methyltrimethoxysilane, 45.9 g of distillated water, and 0.1 g of oxalic acid were put into a vessel equipped with a stirrer, and heated while stirring for 6 hours at a temperature of 60 degree C., thus hydrolyzing the phenyltrimethoxysilane and methyltrimethoxy silane.

Next, propylene glycol monomethyl ether was added into the vessel, and then the methanol produced through the hydrolysis was removed using an evaporator. Finally, a propylene glycol monomethyl ether solution containing polysiloxane with a solid content made to be 55 mass percent was obtained. 0.32 g of 1-(4,7-di-t-butoxy)-naphthyltetrahydrothiophenium trifluoromethanesulfonate as a photo-acid generator was added to the solution, and mixing to homogeneity was carried out, thus obtaining “Composition No. 4”.

[2. Preparation of Composition for Optical Fiber Guide Portion]

[Composition No. 5]

The system of a flask equipped with a dry ice/methanol reflux tube was purged with nitrogen, and then, 1.3 g of 2,2′-azobisisobutyronitrile as a polymerization initiator, and 53.8 g of ethyl lactate were put into the flask and stirred until the polymerization initiator was dissolved. Next, 6.7 g of methacrylic acid, 15.7 g of dicyclopentanyl methacrylate, 9.0 g of styrene, and 13.5 g of n-butyl acrylate were added, and stirring started slowly.

Then, the solution was heated to a temperature of 80 degree C., and at this temperature the polymerization was carried out for 4 hours. Then, the reaction product was added into a large amount of hexane to coagulate the reaction product. Moreover, this coagulated material was resolved into the same amount of tetrahydrofuran, and then the solution was added into a large amount of hexane to be recoagulated. The resolution-recoagulation process was carried out repeatedly three times. The obtained coagulated material was dried in a vacuum for 48 hours at a temperature of 40 degree C., thus obtaining a copolymer (the glass transition temperature: 58 degree C.).

10.0 mass parts of multifunctional acrylate (name of product: M8100 manufactured by TOAGOSEI CO., LTD.), 6.5 mass parts of trimethylolpropane triacrylate, 3.0 mass parts of Irgacure 369 (manufactured by Ciba Specialty Chemicals) as a photo-radical polymerization initiator, and 48.5 mass parts of ethyl lactate were added to 32.0 mass parts of the copolymer, and mixing to homogeneity was carried out, thus obtaining “Composition No. 5”.

[3. Manufacture of Optical Waveguide Chip]

### Example 1

The composition No. 1 obtained by the above method was applied onto a silicon wafer using a spin coater, and dried for 10 minutes at a temperature of 120 degree C., and then irradiated by UV rays having a wavelength of 365 nm with intensity of 20 mW/cm² for 1 minutes using an exposure apparatus (i.e. photo aligner manufactured by SUSS MicroTec). Moreover, the composition was heated for 1 hour at a temperature of 200 degree C., thus forming a lower clad layer having a thickness of 58 μm. The lower clad layer had a refractive index of 1.439 at 1,550 nm.

Next, composition No. 3 was applied onto the lower clad layer using a spin coater, and dried for 5 minutes at a temperature of 100 degree C., and then, exposed to UV rays having a wavelength of 365 nm with intensity of 20 mW/cm² for 10 seconds through a photo-mask having a 9 μm-width waveguide pattern using the exposure apparatus. The support was then heated for 1 minute at a temperature of 100 degree C., and immersed into a developer which is a 5% tetramethylammonium hydrooxide (TMAH) aqueous solution to resolve unexposed portions, and then washed with water. After that, exposure was carried out for 2 minutes by irradiating UV rays and heating was carried out for 1 hour at a temperature of 200 degree C., thus forming a 9 μm-width core portion. The core portion had a refractive index of 1.445 at a light wavelength of 1,550 nm.

Moreover, composition No. 1 was applied onto the surface of the core portion and the lower clad layer, and dried for 10 minutes at a temperature of 120 degree C., and then irradiated with UV rays having a wavelength of 365 nm with intensity of 20 mW/cm² for 10 minutes. Besides, the composition was heated for 1 hour at a temperature of 300 degree C., thus forming a 15 μm-width upper clad layer. The upper clad layer had a refractive index of 1.445 at a light wavelength of 1,550 nm.

Next, composition No. 5 was applied onto the silicon wafer and dried for 10 minutes at a temperature of 100 degree C., and then, irradiated with UV rays having a wavelength of 365 nm with intensity of 20 mW/cm² for 2 minutes. Moreover, the composition was heated for 1 hour at a temperature of 150 degree C., thus forming an optical fiber guide portion (thickness: 70 μm).

After that, an optical fiber having a diameter of 125 μm was set along the optical fiber guide portion and fixed by an UV adhesive (name of product: GA700L manufactured by NTT-Advanced Technology Corporation). A glass plate (thickness: 100 μm) was then fixed onto the upper surface of the optical waveguide by a UV adhesive, thus accomplishing a linear optical waveguide chip (length of waveguide: 15 mm).

### Example 2

The optical waveguide chip was manufactured by the same method as that of Example 1, excepting that the glass plate was not set on the upper surface of the optical waveguide.

### Comparative Example 1

The optical waveguide chip was manufactured by the same method as that of practical example 1, excepting that the optical waveguide and the optical fiber guide portion were uniformly and simultaneously formed to have a Y-shape horizontal section by using only one composition for optical waveguide. The material for the optical fiber guide portion was the same as the material for the clad layers of optical waveguide (i.e. composition No. 1).

### Example 3

The optical waveguide chip was manufactured by the same method as that of Example 1, excepting that composition No. 2 was used instead of composition No. 1 and composition No. 4 was used instead of composition No. 3.

### Example 4

The optical waveguide chip was manufactured by the same method as that of Example 3, excepting that the glass plate was not set on the upper surface of the optical waveguide.

### Comparative Example 2

The optical waveguide chip was manufactured by the same method as that of Example 3, excepting that the optical waveguide and the optical fiber guide portion were uniformly and simultaneously formed to have a Y-shape horizontal section by using only one composition for optical waveguide. The material for the optical fiber guide portion was the same as the material for the clad layers of the optical waveguide (i.e. composition No. 2).

[4. Evaluation of Optical Waveguide Chip]

(1) Evaluation Method

The characteristics of the optical waveguide chip were evaluated by the following method.

(a) Yield of Manufacturing

In the 100 optical waveguide chips manufactured on a 4-inch silicon wafer, the number of the optical waveguide chip without any damages such as cracks was counted (as X) to obtain the yield of manufacturing (X/100).

(b) Insertion Loss Before Thermal Shock Test

When a light having a wavelength of 1.55 μm entered into one side of the optical waveguide, the amount of the light outgoing from the other side was measured by using a power meter of an actinograph (name of the product: MT9810A manufactured by Anritsu Company), thus obtaining the insertion loss [dB].

(c) Insertion Loss after Thermal Shock Test

The heat cycle in which the optical waveguide chip was left at a temperature of −40 degree C. for 30 minutes, and then, left at a temperature of 85 degree C. for 30 minutes was repeated 500 times, and then, the insertion loss [dB] was obtained by the same method as the above “insertion loss before thermal shock test”.

(2) Result

The results are shown in Tables 1 and 2.

Tables 1 and 2 show that the optical waveguide chip obtained by the method of the present invention (Examples 1 to 4) have smaller insertion loss after thermal shock test than the optical waveguide chip obtained by forming the optical waveguide and the optical fiber guide portion simultaneously and uniformly (Comparative Examples 1 and 2), and that the optical waveguide chip of the present invention keeps its excellent optical characteristics stably over a long period of time even under severe use conditions.

Also, Tables 1 and 2 show that the optical waveguide chip with a cover member on the optical waveguide (Examples 1 and 3) is preferred to the optical waveguide chip without a cover member (Examples 2 and 4) because of its higher yield.

Moreover, Tables 1 and 2 show that, in Examples 1 and 2, wherein the composition having a silanol (Si—OH) group content of from 0 to 50 percent based on the total bonds on Si is used as the radiation-sensitive polysiloxane composition for the optical waveguide, smaller insertion losses before and after thermal shock test and more excellent optical characteristics can be obtained, compared to Examples 3 and 4 wherein the compositions do not have a silanol group content of from 0 to 50 percent.

TABLE 1

| | | Insertion Loss | Insertion Loss after |
|---|---|---|---|
| | Yield of | before Thermal | Thermal Shock Test |
| | Manufacturing | Shock Test (dB) | (dB) |
| Example 1 | 95/100 | 0.7 | 0.8 |
| Example 2 | 94/100 | 0.8 | 15.9 |
| Comparative | 52/100 | 0.8 | 0.9 |
| Example 1 | | | |

TABLE 2

| | | Insertion Loss | Insertion Loss after |
|---|---|---|---|
| | Yield of | before Thermal | Thermal Shock Test |
| | Manufacturing | Shock Test (dB) | (dB) |
| Example 3 | 93/100 | 1.2 | 1.5 |
| Example 4 | 94/100 | 1.2 | 20.5 |
| Comparative | 49/100 | 1.2 | 1.4 |
| Example 2 | | | |

1-3. (canceled)

4. A method for manufacturing an optical waveguide chip having an optical waveguide and an optical fiber guide portion for positioning an optical fiber to be connected with the optical waveguide, which method comprises:
(A) a step for forming an optical waveguide using a radiation-sensitive polysiloxane composition; and
(B) a step for forming an optical fiber guide portion using the same or a different radiation-sensitive composition as/from the material of the optical waveguide.

5. The method for manufacturing an optical waveguide chip according to claim 4, which comprises (C) a step for fixing a cover member on the upper surface of the optical waveguide formed in step (A).

6. The method for manufacturing an optical waveguide chip according to claim 4, wherein the radiation-sensitive polysiloxane composition comprises components
(a) and (b), and has a silanol (Si—OH) group content of from 10 to 50 percent based on the total bonds on Si:
(a) at least one type of compound selected from the group consisting of hydrolysates of hydrolyzable silane compounds represented by formula (1) and condensation products of said hydrolysates,
(R¹)ₚ(R²)_{q}Si (X)_{4-p-q} (1)
wherein R¹ is a non-hydrolyzable organic group having 1 to 12 carbon atoms and at least one fluorine atoms; R² is a non-hydrolyzable organic group having 1 to 12 carbon atoms and no fluorine atoms; X is a hydrolyzable group; p is 1 or 2; and q is 0 or 1; and
(b) a photo-acid generator.

7. The method for manufacturing an optical waveguide chip according to claim 5, wherein the radiation-sensitive polysiloxane composition comprises components (a) and (b), and has a silanol (Si—OH) group content of from 10 to 50 percent based on the total bonds on Si:
(a) at least one type of compound selected from the group consisting of hydrolysates of hydrolyzable silane compounds represented by formula (1) and condensation products of said hydrolysates,
(R¹)ₚ(R²)_{q}Si (X)_{4-p-q} (1)
wherein R¹ is a non-hydrolyzable organic group having 1 to 12 carbon atoms and at least one fluorine atoms; R² is a non-hydrolyzable organic group having 1 to 12 carbon atoms and no fluorine atoms; X is a hydrolyzable group; p is 1 or 2; and q is 0 or 1; and
(b) a photo-acid generator.

8. The method for manufacturing an optical waveguide chip according to claim 4, wherein the optical fiber guide portion comprises a pair of molded products which are formed to have a suitable distance from the optical waveguide and which are apart from each other.

9. The method for manufacturing an optical waveguide chip according to claim 5, wherein the optical fiber guide portion comprises a pair of molded products which are formed to have a suitable distance from the optical waveguide and which are apart from each other.

10. The method for manufacturing an optical waveguide chip according to claim 6, wherein the optical fiber guide portion comprises a pair of molded products which are formed to have a suitable distance from the optical waveguide and which are apart from each other.

11. The method for manufacturing an optical waveguide chip according to claim 7, wherein the optical fiber guide portion comprises a pair of molded products which are formed to have a suitable distance from the optical waveguide and which are apart from each other.
